(19) United States
(12) Patent Application Publication
(10) Pub. No.: US 2024/0029006 A1
(43) Pub. Date: Jan. 25, 2024

(54) DATA MANAGEMENT SYSTEM AND DATA MANAGEMENT METHOD

(71) Applicant: Fujitsu Limited, Kawasaki-shi (JP)

(72) Inventors: Keitaro KOGA, Kawasaki (JP); Koichi MIURA, Numazu (JP); ATSUHITO HIROSE, Odawara (JP); Toshiaki YAMADA, Mishima (JP)

(73) Assignee: Fujitsu Limited, Kawasaki-shi (JP)

(21) Appl. No.: 18/142,364

(22) Filed: May 2, 2023

(30) Foreign Application Priority Data
Jul. 22, 2022 (JP) 2022-117451

(51) Int. Cl. G06Q 10/083

(52) U.S. Cl. CPC G06Q 10/083

(57) ABSTRACT

A data management system includes an operating-mode node, and a standby-mode node, wherein the operating-mode node includes a first memory that includes a temporary storage space, and a first processor coupled to the first memory and the first processor configured to process a received process request, in a case where the received process request is a batch process request which includes a plurality of process commands, sequentially execute the process commands, store process-completion data corresponding to each of the process commands in the temporary storage space every time the execution of each of the process commands is completed, in a case where the process-completion data stored in the temporary storage space is referred to in processing for another process request, transmit predetermined process-completion data to the standby-mode node, and when execution of all the process commands is completed, transmit un-transmitted process-completion data to the standby-mode node to perform data synchronization.

### CROSS-REFERENCE TO RELATED APPLICATION

This application is based upon and claims the benefit of priority of the prior Japanese Patent Application No. 2022-117451, filed on Jul. 22, 2022, the entire contents of which are incorporated herein by reference.

### FIELD

The embodiment discussed herein is related to a data management system and a data management method.

### BACKGROUND

Due to an increasing demand for stay-at-home or the like due to the spread of new coronavirus infection, in recent years, the scale of the E-commerce market for product sales has expanded rapidly. In the E-commerce for product sales, when an order for a commodity is received through a sale site on the Internet, an instruction to ship the commodity is issued to a warehouse or a person in charge of work in the warehouse. The person in charge of work receives the instruction to ship the commodity, picks up the designated commodity and packages the picked commodity, and then pastes a shipment slip. A home delivery business operator receives a request for delivery of the commodity to which the shipment slip is attached, and delivers the commodity as a parcel to a destination.

An example of a delivery procedure of the home delivery business operator will be described. A parcel handed over to the home delivery business operator is brought to a base shop in a delivery area of the customer's house via a plurality of relay points of the home delivery business operator by trunk transport. The parcel sent to the base shop is delivered to a delivery shop in charge of delivery, and the parcel is sorted and loaded into a car for each charge area. Finally, a home delivery driver delivers the commodity, which is a parcel, to the destination.

In recent years, for the home delivery business operator, there is an increasing demand for visualization of a parcel state in a distribution process in order to manage the parcel state or provide information to customers. To meet this demand, the home delivery business operator promotes visualization of delivery information such as incoming warehousing, incoming warehousing inspection, inventory management, picking, sorting, outgoing warehousing, outgoing warehousing inspection, product management, position tracking, and anti-theft. For example, the home delivery business operator implements visualization of various delivery information, by reading a bar code of a shipment slip and updating tracking data of the shipment slip in a home delivery system in each process of the distribution.

For example, the home delivery system has a configuration including a reception server and a processing server that performs processing such as visualization. The reception server receives inspection data or tracking data of a parcel from a terminal device operated by a worker, and requests the processing server to perform the processing. According to the request for the processing from the reception server, the processing server performs the processing such as visualization. Since a large number of pieces of data are transmitted to the reception server, it is desirable that the reception server efficiently transmit the data to the processing server and cause the processing server to quickly perform the processing. An in-memory database or the like is used for the processing server in order to increase a processing speed. Along with the rapid expansion of the market scale of the E-commerce for product sales, the number of products for which delivery is requested to a home delivery business operator is also rapidly increased, so that further speed-up of the processing performance of the home delivery system is demanded.

For example, in a case where the home delivery system is stopped and the business is not restarted immediately, it is difficult for the home delivery business operator to perform a delivery as a scheduled time. Accordingly, in order to enable a business to be continued even in a case where the processing server fails in the home delivery system, the processing servers are clustered to constitute a system, thereby increasing availability. For example, the cluster system may employ a configuration called hot standby in which an active node that is an operating-mode server that receives data and actually performs processing and a standby node that is a standby-mode server are disposed. A plurality of standby nodes may be disposed, one of which is switched to an active node, and the other of which continue to operate as standby-mode servers.

An example of an operation of the cluster system that guarantees data in the hot standby will be described. The active node and the standby node hold identical data, and when an update process occurs in the active node, an update difference that is a difference between data before update and data after update generated by the update is transmitted to the standby node, and thus data synchronization is performed. This data synchronization is referred to as mirroring. There are two methods in which a timing, at which the update difference of the data for starting mirroring is determined, is different. One method is a “normal commit” in which update differences are reflected in a batch manner in the standby node by executing a commit of results of plural pieces of processing. Another method is an “auto-commit” in which an update difference is automatically and sequentially reflected in the standby node for each processing.

According to the auto-commit method, the active node commits an update difference every time one piece of processing is completed during performing operations in a data operation space included in the active node, and synchronizes data to the standby node with the execution of the commit as a trigger. After the operation in the data operation space, the active node transmits information on the update difference to the standby node. The standby node includes a mirroring buffer that is a temporary storage space for mirroring. The standby node temporarily stores the update difference in the mirroring buffer, and notifies the active node of completion of synchronization. When receiving the synchronization completion notification, the active node reflects the update difference in a memory table of the active node. After that, the active node returns to the processing with a client. The standby node asynchronously reflects the update difference stored in the mirroring buffer in a memory table of the standby node, and completes the mirroring process.

As a technology for making a database (DB) or the like redundant, the following technology is proposed. For example, a technology is proposed in which update data is stored in an accumulation buffer, the update data is stored in an update data reflection buffer every time a transaction is ended, the update data is reflected in a sub-system DB when a reflection interval is reached, and the accumulation buffer up to a synchronization point is discarded when a failure occurs. Another technology is proposed in which a query is registered in a transaction queue, in a case where the query is committed, uncopied queries are collectively and synchronously copied to a secondary site, and when a failure occurs, a gray transaction is examined to perform manual recovery. Still another technology is proposed in which a commit request related to a transaction to be processed is accumulated, and a batch commit process is executed when the accumulated number reaches a certain value.

Japanese Laid-open Patent Publication No. H02-292641, Japanese Laid-open Patent Publication No. 2004-295540, and Japanese Laid-open Patent Publication No. H07-271643 are disclosed as related art.

### SUMMARY

According to an aspect of the embodiment, a data management system includes an operating-mode node, and a standby-mode node, wherein the operating-mode node includes a first memory that includes a temporary storage space, and a first processor coupled to the first memory and the first processor configured to process a received process request, in a case where the received process request is a batch process request which includes a plurality of process commands, sequentially execute each of the process commands included in the batch process request, store process-completion data corresponding to each of the process commands in the temporary storage space every time the execution of each of the process commands is completed, in a case where the process-completion data stored in the temporary storage space is referred to in processing for another process request, transmit predetermined process-completion data to the standby-mode node based on a reference state of the temporary storage space, and when execution of all the process commands included in the batch process request is completed, transmit un-transmitted process-completion data, which is process-completion data not yet transmitted, to the standby-mode node to perform data synchronization.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating a system configuration of an information processing system according to an embodiment;

FIG. 2 is a diagram illustrating processing for a batch process request;

FIG. 3 is a block diagram illustrating details of a cluster system;

FIG. 4 is a diagram illustrating a data structure of a log saved in a data operation space;

FIG. 5 is a diagram illustrating a data structure of a log saved in a temporary storage space;

FIG. 6 is a diagram illustrating a structure of a record in a memory table;

FIG. 7 is a diagram illustrating a data structure of data transmitted from an active node to a standby node at a time of mirroring;

FIG. 8 is a diagram illustrating a data structure of mirror data;

FIG. 9 is a diagram illustrating an overview of an operation in a case where process-completion data stored in the temporary storage space is referred to;

FIG. 10 is a diagram illustrating an overview of an operation in a case where switching of the active node occurs during execution of the processing for the batch process request;

FIG. 11 is a first diagram illustrating a transition of data included in the active node when the batch process request is processed;

FIG. 12 is a second diagram illustrating the transition of data included in the active node when the batch process request is processed;

FIG. 13 is a diagram illustrating an example of a transition of a state of the active node and the standby node in a case where reference is made during the processing for the batch process request;

FIG. 14 is a sequence diagram illustrating an operation of the cluster system in a case where a reference is not performed during the processing for the batch process request;

FIG. 15 is a sequence diagram illustrating an operation of the cluster system in a case where a reference is performed during the processing for the batch process request;

FIGS. 16A and 16B are sequence diagrams illustrating an operation of the cluster system in a case where a reference is performed during the processing for the batch process request and switching occurs;

FIG. 17 is a flowchart illustrating processing by the active node when the batch process request is received;

FIG. 18 is a flowchart illustrating processing by the active node when a reference request is received;

FIG. 19 is a flowchart of a reception process executed by the standby node;

FIG. 20 is a flowchart of transmission processing for the batch process request by a client application; and

FIG. 21 is a diagram illustrating a hardware configuration of a computer.

### DESCRIPTION OF EMBODIMENT

In mirroring by the auto-commit method, in a case where the client requests the server of the active node to perform processing by using an application programming interface (API), a plurality of APIs may be collectively requested as a batch process. By collecting the plurality of APIs, it is possible to reduce the number of communications between the client and the server and increase a processing speed. In the cluster system having the configuration in this manner, it is conceivable to further increase efficiency of the processing between the active node and the standby node, and further increase the processing speed.

A commit process is added to each of the APIs for which the auto-commit is notified. Thus, even in a case where the batch process of the plurality of APIs is requested in the auto-commit method, the commit process is executed for each auto-commit notification. Accordingly, a method is conceivable in which the number of times of data synchronization between the active node and the standby node is reduced by executing the commit process, which is executed every time for each API for which the auto-commit is notified, at an end without executing the commit process at a time other than the end.

Meanwhile, during processing for a batch process request including a plurality of APIs from a certain client application, even in a case where process-completion data exists for an API for which the processing is completed, another client application is prohibited from referring to the data in a new state after the update. Thus, in a case where a batch process request including a large number of APIs is made, there is a risk that a long waiting time occurs for the another client application to use the updated data. As described above, it is difficult to improve system reliability of the cluster system in the related art.

Hereinafter, an embodiment of a data management system and a data management method disclosed herein is described in detail with reference to the accompanying drawings. The data management system and the data management method disclosed in the present application are not limited to the following embodiment.

### Embodiment

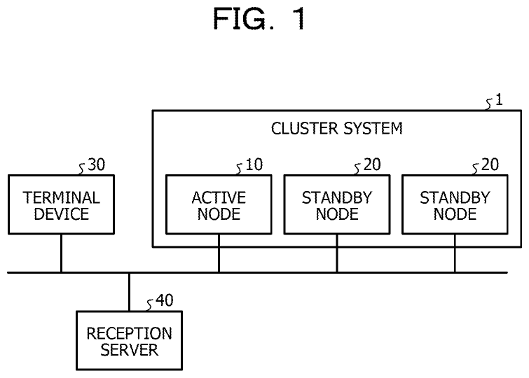

FIG. 1 illustrates a system configuration of an information processing system according to the embodiment. An information processing system according to the present embodiment is, for example, a home delivery system in which resumption of work is requested in several seconds after a failure of an operating-mode server. The information processing system includes a cluster system 1 and a terminal device 30. The information processing system may include a reception server 40.

A client application runs on the terminal device 30. The client application running on the terminal device 30 transmits a process request by using an API to an active node 10 operating on the cluster system 1, and receives a response to the process request. The process request using the API includes a batch process request in which processing of a plurality of APIs are collected. For example, the terminal device 30 is a computer used by a worker in charge of a warehouse.

The cluster system 1 includes the active node 10 that is an operating-mode server and a standby node 20 that is a standby-mode server. The cluster system 1 may include a plurality of standby nodes 20. Mirroring by an auto-commit method is employed in the cluster system 1. The cluster system 1 is an example of a “data management system”.

For example, the active node 10 performs processing for the process request using the API transmitted from the terminal device 30. After that, the active node 10 transmits a process result to the terminal device 30. The active node 10 also processes the batch process request for the APIs transmitted from the terminal device 30.

The active node 10 performs mirroring to transmit data of the active node 10 to the standby node 20, and perform data synchronization of the data of the active node 10 and data of the standby node 20. In a case where there are plurality of standby nodes 20, the data synchronization is performed between the active node 10 and all the standby nodes 20. In a case where the active node 10 is shut down due to a failure or the like, the standby node 20 is switched to a new active node 10. In a case where there are the plurality of standby nodes 20, one standby node 20 is switched to the new active node 10, and the remaining standby nodes 20 are standby nodes 20 for the new active node 10.

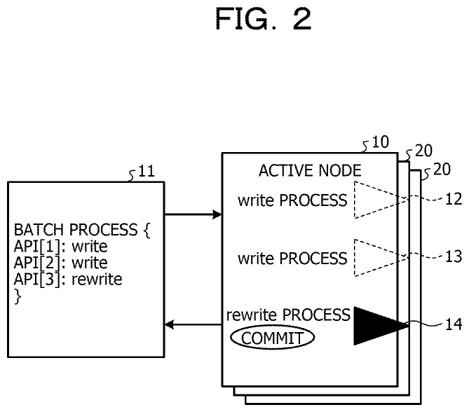

FIG. 2 is a diagram illustrating processing for a batch process request. For example, as illustrated in FIG. 2, the batch process request includes a request list 11 in which APIs for three pieces of processing of writing first data, writing second data, and rewriting data are collectively registered in order. The terminal device 30 transmits the batch process request including the request list 11 to the active node 10. As illustrated in FIG. 2, an index may be added to each API in the request list 11. Alternatively, the request list 11 may have a structure in which APIs may be distinguished in accordance with an execution order and an index may be allocated.

The active node 10 receives the batch process request including the request list 11. The active node 10 sequentially processes the APIs for the three pieces of processing of writing first data, writing second data, and rewriting data. In a case where the batch process request including the request list 11 is received, the active node 10 commits an update difference after the processing for the API of rewriting data, which is the last API, and collectively performs mirroring 14 for the update differences up to that time on the standby node 20. In this case, the active node 10 does not commit the update difference after the processing for the API of writing first data and after the processing for the API of writing second data. For example, the active node 10 does not perform mirroring 12 after the processing for the API of writing first data and mirroring 13 after the processing for the API of writing second data. Meanwhile, in addition to the mirroring illustrated in FIG. 2, when process-completion data generated during the processing for the batch process request is referred to, the active node 10 according to the present embodiment transmits the process-completion data based on the reference to the standby node 20. Details of the data synchronization in the cluster system 1 will be described below.

The description is continued by returning to FIG. 1. As illustrated in FIG. 1, the information processing system may include the reception server 40. In this case, the client application runs on the reception server 40.

For example, the reception server 40 receives a process request using an API such as a batch process request from the terminal device 30. The reception server 40 adjusts a timing or the like of processing for each process request, and transmits the process request received from the terminal device 30 to the active node 10. After that, the reception server 40 receives, from the active node 10, a response to the process request notifying of a process result. The reception server 40 transmits the received response to the terminal device 30. As described above, the client application may run on the reception server 40.

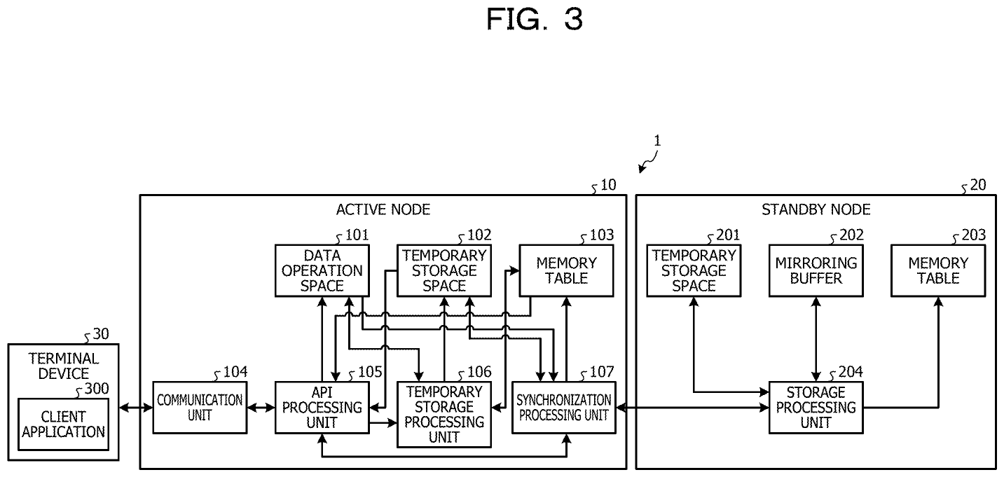

FIG. 3 is a block diagram illustrating details of the cluster system 1. FIG. 3 illustrates a function related to execution of data synchronization, and other functions are omitted. A representative one of the standby nodes 20 is described.

Next, the data synchronization by the cluster system 1 will be described in detail with reference to FIG. 3. A case where a client application 300 runs on the terminal device 30 will be described below. Meanwhile, even in a case where the client application 300 runs on the reception server 40, the cluster system 1 performs the same operation. Although functions of the active node 10 and the standby node 20 will be described below, in a case where the standby node 20 is switched to an active node 10, the new active node 10 has the same function as the function of the active node 10 before the switching.

The client application 300 runs on the terminal device 30. The client application 300 transmits various process requests including a batch process request to the active node 10. After that, the client application 300 receives a response to the process request from the active node 10, and continues the processing.

When switching of the active node 10 is detected in a case where the batch process request is transmitted, one of the standby nodes 20 is switched to the new active node 10. The client application 300 transmits a re-request for the batch process request to the active node 10. After that, the client application 300 receives a response to the process request from the active node 10, and continues the processing.

As illustrated in FIG. 3, the active node 10 includes a data operation space 101, a temporary storage space 102, a memory table 103, a communication unit 104, an API processing unit 105, a temporary storage processing unit 106, and a synchronization processing unit 107.

The communication unit 104 receives various process requests such as a batch process request transmitted from the client application 300. The process request may include a process request that includes a reference request as described below. The communication unit 104 outputs the received process request to the API processing unit 105. After that, the communication unit 104 receives a process result of the output process request from the API processing unit 105. In a case where the output process request is normally processed, the communication unit 104 transmits the process result to the client application 300 as a response to the process request. In a case where an abnormality occurs in the processing for the process request, the communication unit 104 transmits an abnormality occurrence notification as the response to the client application 300. By the communication unit 104 returning the response to the client application 300, the active node 10 returns to the processing with the client application 300.

The data operation space 101 is a space used for a data operation when the API processing unit 105 performs processing for an API in accordance with a process request. The data operation space 101 stores, as a commit log, process-completion data obtained as a result of the processing for the API by the API processing unit 105. The data operation space 101 is provided for each thread in response to the process request transmitted from the client application 300. Data stored in the data operation space 101 for a certain thread is not used for processing for another thread. For example, the API processing unit 105 is prohibited from referring to the process-completion data stored in the data operation space 101 for a process request from a certain client application 300, in processing for another process request from another client application 300. Although process requests from two different client applications 300 will be described as an example of processing for respective different threads below, different process requests from the same client application 300 also correspond to processing for respective different threads.

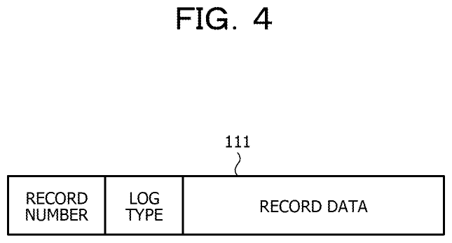

FIG. 4 is a diagram illustrating a data structure of a log saved in a data operation space. As illustrated in FIG. 4, a commit log having a data structure 111 that includes a record number, a log type, and record data is stored in the data operation space 101. Process-completion data is stored in the record data. The log type is information indicating a type of process executed when the process-completion data is generated. For example, in the log type, “U” represents an update process, “I” represents an insertion process, and “D” represents a deletion process. The record number is identification information allocated to each record data.

The temporary storage space 102 is provided for the purpose of resolving a long-time standby for an access to updated data during processing for a batch process request including a plurality of APIs. Process-completion data in the active node 10 is stored and accumulated in the temporary storage space 102. Accordingly, another client application 300 other than the client application 300 that has issued the batch process request may proceed with processing by referring to the process-completion data in the temporary storage space 102.

Meanwhile, simply adding the temporary storage space 102 may cause the following problem. Here, another client application 300 other than the client application 300 that has issued the batch process request is simply referred to as “another client application 300”. For example, in a case where the temporary storage space 102 is simply provided, some pieces of process-completion data during the processing for the batch process request are accumulated in the active node 10, and are not transmitted to the standby node 20. In this state, when the another client application 300 commits processing by referring to the process-completion data stored in the temporary storage space 102, the standby node 20 does not hold the referred process-completion data at a timing of the commit. Thus, when the active node 10 shuts down in a period from the timing of the commit to a commit of the batch process request, the process-completion data referred to by the another client application 300 is erased. By contrast, in a case where the processing by the another client application 300 using the process-completion data is completed before the active node 10 shuts down, a process result is reflected in the standby node 20. For example, even when the active node 10 shuts down, the result of the processing performed by the another client application 300 remains in a memory table 203 of the standby node 20. In this case, a process result based on non-existing data remains in the memory table 203, and a data mismatch occurs in the active node 10 after the switching.

With a technology of making a DB redundant by using an accumulation buffer and an update data reflection buffer, data is reflected at a scheduled timing. Thus, even when this technology is used, it is difficult to cope with the data mismatch at a time of the shutdown of the active node 10 in the cluster system 1 in which an update difference is reflected for each batch process. With a technology of collectively and synchronously copying a query registered in a transaction queue when a commit occurs, a standby-mode server executes the query, and data transfer is not performed. Thus, even when this technology is used, it is difficult to cope with the data mismatch at a time of the shutdown of the active node 10 due to a difference between data held in the active node 10 and data held in the standby node 20. In a technology of executing a batch commit process when an accumulated number of commit requests reaches a certain value, reference by another transaction to process-completion data processed by a specific transaction is not considered. Thus, it is difficult to cope with a mismatch of data referenced by the another client application 300 when the active node 10 shuts down.

As described above, in a case where the temporary storage space 102 is simply added, there is still an insufficient portion for improving reliability of the cluster system 1. Even when the related art is used, it is difficult to obtain sufficient reliability of the cluster system 1. Accordingly, in order to solve the occurrence of the data mismatch when the active node 10 shuts down, the cluster system 1 according to the present embodiment has the following configuration.

Every time processing for each API is completed when the API processing unit 105 processes a batch process request, the temporary storage space 102 temporarily stores, as a log, a copy of process-completion data for an API stored in the data operation space 101. The process-completion data stored in the temporary storage space 102 may be used in processing by the another client application 300 before a commit. For example, the API processing unit 105 may refer to the process-completion data stored in the temporary storage space 102, among pieces of process-completion data generated in processing for a process request from a certain client application 300, for processing by another client application 300.

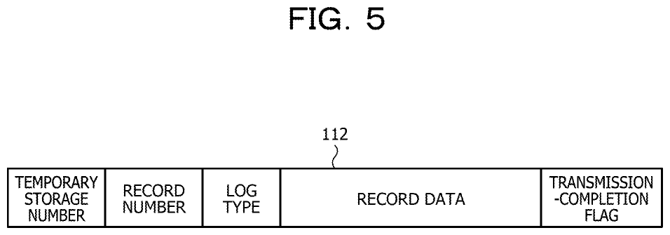

FIG. 5 is a diagram illustrating a data structure of a log saved in a temporary storage space. As illustrated in FIG. 5, in the temporary storage space 102, a log having a data structure 112 that includes a temporary storage number, a record number, a log type, record data, and a transmission-completion flag is stored. Process-completion data is stored in the record data. The record number, the log type, and the record data are the same as the record number, the log type, and the record data in the data structure 111 of the data operation space 101. The temporary storage number is a value corresponding to an index of each API of the request list 11 included in a batch process request, and is a destination indicated by a pointer from a record of the memory table 103 which will be described below. The temporary storage number is used to determine whether or not a log including a process result of a specific API by the API processing unit 105 already exists in the temporary storage space 102. The transmission-completion flag is information indicating whether or not the corresponding log is transmitted to the standby node 20. The transmission-completion flag is ON in a case where the corresponding record data is already transmitted to the standby node 20, and is OFF in a case where the corresponding record data is not yet transmitted.

The memory table 103 is a space in which process-completion data is stored in a case where a requested process is completed and a final update difference is committed. The process-completion data stored in the memory table 103 is data for which synchronization with the standby node 20 is completed.

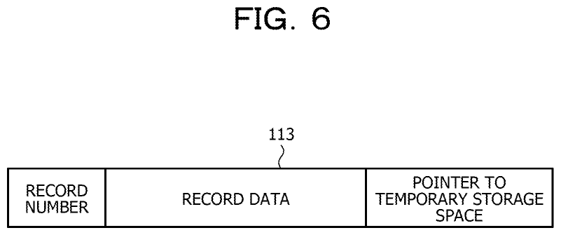

FIG. 6 is a diagram illustrating a structure of a record in a memory table. As illustrated in FIG. 6, in the memory table 103, a record having a data structure 113 that includes a record number, a record data, and a pointer to temporary storage space is stored. The record number and the record data are the same as the record number and the record data in the data structure 111 of the data operation space 101. As the pointer to temporary storage space, in a case where a log having the same record number exists in the temporary storage space 102, a pointer indicating the temporary storage number of the log is stored. For example, a case where specific record data stored in the memory table 103 is updated based on a batch process request will be described. In this case, in a state before a commit of an update difference, record data included in the log in the temporary storage space 102 corresponding to the temporary storage number indicated by the pointer to the temporary storage space 102 is data after the update of the specific record data.

The description is continued by returning to FIG. 3. From the communication unit 104, the API processing unit 105 receives an input of a process request transmitted from the client application 300. In a case where the process request is a batch process request, the API processing unit 105 sequentially processes APIs included in the batch process request in accordance with a processing order designated in the request list 11.

The operation of the API processing unit 105 will be described separately for a case where the active node 10 is in a state where switching does not occur and for a case where the standby node 20 is switched to an active node 10 after the occurrence of switching.

In the case of the active node 10 in the state where the switching does not occur, the API processing unit 105 sequentially processes the APIs included in the batch process request, and stores, every time the processing for each API is completed, a process result of the API including process-completion data in the data operation space 101 in a format of a commit log. At this time, when an index is not added to each API in the request list 11, the API processing unit 105 may allocate an index to the API by an algorithm determined based on the processing order designated by the request list 11. In this case, the API processing unit 105 notifies the temporary storage processing unit 106 of the index in the request list 11 allocated to each API.

Next, the API processing unit 105 determines whether or not the processed API is the last API in the batch process request. When the processed API is not the last API, the API processing unit 105 notifies the temporary storage processing unit 106 of the process completion of one API. After that, the API processing unit 105 moves to the processing for the next API.

By contrast, when the processed API is the last API, the API processing unit 105 notifies the synchronization processing unit 107 of the process completion of the batch process request. After that, the API processing unit 105 receives, from the synchronization processing unit 107, a notification of the reflection completion of the update difference in the memory table 103. The API processing unit 105 outputs the process result to the communication unit 104.

Meanwhile, in a case where-processing for any API in the batch process request may not be normally performed, the API processing unit 105 outputs an abnormality occurrence notification to the communication unit 104. In this case, the API processing unit 105 ends the processing for the batch process request.

In a case where the standby node 20 is switched to an active node 10 during the processing for the batch process request, the new active node 10 receives a re-request for the batch process request from the client application 300. In this case, among the APIs included in the batch process request, in some cases, an API of which the process result is already stored as a log in the temporary storage space 102 exists. Accordingly, in a case where the standby node 20 is switched to an active node 10, the API processing unit 105 performs the following operation.

The API processing unit 105 sequentially sets the APIs included in the batch process request as process targets. The API processing unit 105 determines whether or not a log, which has a temporary storage number corresponding to an index in the request list 11 of the API as the process target, already exists in the temporary storage space 102. When the log that has the temporary storage number corresponding to the index of the API as the process target already exists in the temporary storage space 102, the API processing unit 105 skips processing for the API, and moves to processing for the next API by setting the next API as the process target.

By contrast, when the log having the temporary storage number corresponding to the index of the API as the process target does not exist in the temporary storage space 102, the API processing unit 105 performs processing for the API as the process target. After that, the API processing unit 105 stores the process result of the API as the process target in the data operation space 101 in a format of a commit log.

Next, the API processing unit 105 determines whether or not the processed API is the last API of the batch process request. When the processed API is not the last API, the API processing unit 105 notifies the temporary storage processing unit 106 of the process completion of one API. After that, the API processing unit 105 moves to the processing for the next API.

By contrast, when the processed API is the last API, the API processing unit 105 notifies the synchronization processing unit 107 of the process completion of the batch process request. After that, the API processing unit 105 receives, from the synchronization processing unit 107, a notification of the reflection completion of the update difference in the memory table 103. The API processing unit 105 outputs the process result to the communication unit 104. Meanwhile, also in this case, when processing for any of the APIs is not normally ended, the API processing unit 105 outputs an abnormality occurrence notification to the communication unit 104.

In a case where the process request transmitted from the client application 300 is not the batch process request, the API processing unit 105 performs processing for an API designated by the process request. After the processing for the API is completed, the client application 300 notifies the synchronization processing unit 107 of the process completion of the process request. After that, the API processing unit 105 receives, from the synchronization processing unit 107, a notification of the reflection completion of the update difference in the memory table 103. The API processing unit 105 outputs the process result to the communication unit 104. Meanwhile, also in this case, when the processing for the API is not normally ended, the API processing unit 105 outputs an abnormality occurrence notification to the communication unit 104.

In a case where a data reference request is included in the process request from the client application 300, the API processing unit 105 refers to a record of data designated by a reference request in the memory table 103. The API processing unit 105 determines whether or not the pointer to temporary storage space of the referred record is in an initial state.

When the pointer to temporary storage space is in the initial state, the API processing unit 105 refers to data included in the record data of the record in the memory table 103. After that, the API processing unit 105 uses the referenced data to perform the processing for the API included in the process request. After the processing is completed, the API processing unit 105 notifies the synchronization processing unit 107 of the process completion of the process request. In this case, since the referenced data is not process-completion data generated by the batch process request being executed, a data mismatch at a time of the occurrence of the switching may not be considered.

By contrast, when a pointer is stored as the pointer to temporary storage space, the API processing unit 105 identifies a log in the temporary storage space 102 having a temporary storage number indicated by the pointer. The API processing unit 105 refers to process-completion data that is record data of the identified log in the temporary storage space 102.

Next, the API processing unit 105 determines whether or not the temporary storage number of the log including the referred process-completion data is larger than a value of a maximum transmission number stored in the API processing unit 105. The maximum transmission number is the maximum number among the temporary storage numbers of the logs, which are stored in the temporary storage space 102 and for which transmission to the standby node 20 is completed, and an initial value of the maximum transmission number is a value smaller than the minimum value of the temporary storage number. In a case where the temporary storage number of the log including the referred process-completion data is larger than a value of the maximum transmission number, the API processing unit 105 stores the temporary storage number of the log including the referred process-completion data as the maximum transmission number to update the value of the maximum transmission number.

After that, the API processing unit 105 uses the referred process-completion data to process the API included in the process request including the reference request. After the processing for the process request including the reference request is completed, the API processing unit 105 notifies the synchronization processing unit 107 of an instruction to transmit a log having a transmission number equal to or lower than the maximum transmission number in the temporary storage space 102 and the process completion of the process request including the reference request. After that, the API processing unit 105 receives a notification of reflection completion of an update difference from the synchronization processing unit 107. The API processing unit 105 outputs the process result to the communication unit 104. Meanwhile, also in this case, when the processing for the API is not normally ended, the API processing unit 105 outputs an abnormality occurrence notification to the communication unit 104.

Every time the processing for each API included in the batch process request is completed, the temporary storage processing unit 106 receives a notification of the process completion of one API from the API processing unit 105 when the API is not the last API. After that, the temporary storage processing unit 106 acquires a commit log in which the process result of the notified API is registered, from the data operation space 101. The temporary storage processing unit 106 adds a temporary storage number corresponding to an index in the request list 11 of the API to the acquired commit log, sets the transmission-completion flag to OFF, and registers the resultant log in the temporary storage space 102 as a log. The temporary storage processing unit 106 deletes the acquired commit log from the data operation space 101.

Next, the temporary storage processing unit 106 refers to the memory table 103 to determine whether or not a record having the same record number as the record number included in the log stored in the temporary storage space exists in the memory table 103. For example, in a case where the record having the same record number exists in the memory table 103, the temporary storage processing unit 106 stores a pointer to the temporary storage number of the log stored in the temporary storage space 102 as the pointer to temporary storage space of the record.

The information on the pointer to the temporary storage number stored in the memory table 103 of the active node 10 is not synchronized with the memory table 203 of the standby node 20. Accordingly, in a case where the standby node 20 is switched to an active node 10, the temporary storage processing unit 106 rewrites the pointer indicating the temporary storage number of the temporary storage space 102 from the memory table 103 immediately after the switching.

For example, the temporary storage processing unit 106 of the new active node 10 refers to the logs stored in the temporary storage space 102 sequentially from a head. For a log for which the transmission flag is ON, the temporary storage processing unit 106 searches the memory table 103 for a record having the record number, by using the record number of the log in the temporary storage space 102 as a search key. The temporary storage processing unit 106 registers the temporary storage number of the log of the temporary storage space 102 of the search source as the pointer to temporary storage space of the found record. On the other hand, for a log for which the transmission flag is OFF, the temporary storage processing unit 106 registers a pointer at a time of re-execution of processing for a batch process request according to a re-request for the batch process request from the client application 300.

After the processing for all the APIs included in the batch process request are completed, the synchronization processing unit 107 receives a notification of the process completion of the batch process request from the API processing unit 105. After that, the synchronization processing unit 107 acquires a commit log of the processing for the last API in the batch process request from the data operation space 101. The synchronization processing unit 107 acquires, from the temporary storage space 102, a log in which the transmission flag is OFF among the logs of the process result of APIs other than the last API of the batch process request. For example, the synchronization processing unit 107 does not acquire a log of process-completion data that is referred to by another client application 300 during the processing for the batch process request and is already transmitted to the standby node 20. The synchronization processing unit 107 transmits, to the standby node 20, transmission data for mirroring in which the log of the process result of each API of the batch process request is collected. At this time, the synchronization processing unit 107 transmits a notification of the commit of the update difference of the batch process request to the standby node 20.

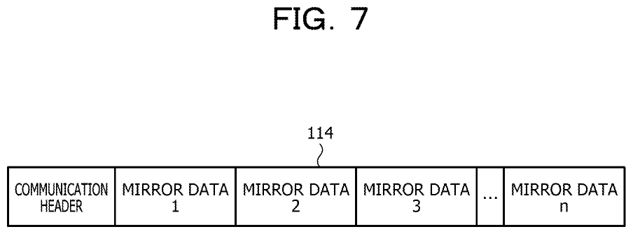

FIG. 7 is a diagram illustrating a data structure of data transmitted from an active node to a standby node at a time of mirroring. The synchronization processing unit 107 creates transmission data for mirroring having a data structure 114 illustrated in FIG. 7. As illustrated in FIG. 7, in the transmission data for mirroring, mirror data of each processing for an API is stored after a communication header.

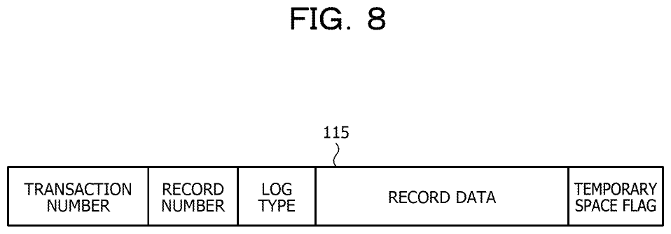

FIG. 8 is a diagram illustrating a data structure of mirror data. As illustrated in FIG. 8, each mirror data has a data structure 115 that includes a transaction number, a record number, a log type, record data, and a temporary space flag. As the record number, the log type, and the record data, the record number, the log type, and the record data in the data operation space 101 and the temporary storage space 102 are used. The temporary space flag is information indicating whether the data is to be stored in a temporary storage space 201 or a mirroring buffer 202 in the standby node 20. A case where the temporary space flag is “ON” indicates data to be stored in the temporary storage space 201. A case where the temporary space flag is “OFF” indicates data to be stored in the mirroring buffer 202. After processing for all APIs included in a batch process request are completed, in a case where a log of a process result of each API of the batch process request is transmitted, the synchronization processing unit 107 sets the temporary space flag of the mirror data of each log to OFF.

From the standby node 20, the synchronization processing unit 107 receives a notification of reception (reception response) to the transmission of the transmission data for mirroring. The synchronization processing unit 107 stores a record including each information on a commit log of the process result of the last API of the batch process request and a log stored in the temporary storage space 102, in the memory table 103 to reflect an update difference. The synchronization processing unit 107 initializes the pointer to temporary storage space of the record with which the update difference is reflected in the memory table 103. After that, the synchronization processing unit 107 notifies the API processing unit 105 of the reflection completion of the update difference.

In a case of a process request including a reference request, the synchronization processing unit 107 receives, from the API processing unit 105, an instruction to transmit a log having a temporary storage number equal to or lower than a value of a maximum transmission number in the temporary storage space 102 and a notification of completion of processing for the process request. Among the logs having the temporary storage number equal to or lower than the value of the maximum transmission number, the synchronization processing unit 107 acquires a log in which a transmission-completion flag is OFF, from the temporary storage space 102. That is, the synchronization processing unit 107 does not acquire a log that is already transmitted to the standby node 20 even when the log has the temporary storage number equal to or lower than the value of the maximum transmission number. Hereinafter, among the logs having the temporary storage number equal to or lower than the value of the maximum transmission number in the temporary storage space 102, a log in which the transmission-completion flag is OFF is referred to as an “un-transmitted log with equal to or lower than the maximum transmission number”. The synchronization processing unit 107 acquires a commit log of the process request including the reference request for which the notification of the process completion is received, from the data operation space 101.

The synchronization processing unit 107 creates mirror data of each of the un-transmitted log with equal to or lower than the maximum transmission number and the commit log of the process request including the reference request. In a case of the mirror data of the un-transmitted log with equal to or lower than the maximum transmission number, the synchronization processing unit 107 sets the temporary space flag to ON. In a case of the mirror data of the commit log of the process request including the reference request, the synchronization processing unit 107 sets the temporary space flag to OFF. After that, the synchronization processing unit 107 generates transmission data for mirroring including the created each mirror data. The synchronization processing unit 107 transmits the generated transmission data for mirroring to the standby node 20.

After that, the synchronization processing unit 107 receives, from the standby node 20, a notification of reception (reception response) to the transmission of the transmission data for mirroring. The synchronization processing unit 107 stores in the memory table 103 a record, in which information included in the commit log of the process request including the reference request for which the notification of the process completion is received is registered, to reflect an update difference. The synchronization processing unit 107 sets the transmission-completion flag of the un-transmitted log with equal to or lower than the maximum transmission number in the temporary storage space 102, to ON. After that, the synchronization processing unit 107 notifies the API processing unit 105 of the reflection completion of the update difference.

Returning back to FIG. 3, the standby node 20 will be described. The standby node 20 includes the temporary storage space 201, the mirroring buffer 202, the memory table 203, and a storage processing unit 204.

The temporary storage space 201 is a space for storing, among logs stored in the temporary storage space 102 of the active node 10, a log having process-completion data referred to by a process request from another client application 300 and logs having process-completion data therebefore. For example, the temporary storage space 201 is a space for temporarily storing a log having a temporary storage number equal to or lower than a value of a maximum transmission number, among the logs stored in the temporary storage space 102 of the active node 10. The log stored in the temporary storage space 201 also has the data structure 112 in the same manner as the data structure of the log in the temporary storage space 102 of the active node 10 illustrated in FIG. 5. In a case where the standby node 20 is switched to an active node 10, the temporary storage space 201 functions as the temporary storage space 102 of the active node 10.

The mirroring buffer 202 is a space for storing process-completion data committed after processing for the process request is completed, at a time of mirroring execution. The process-completion data stored in the mirroring buffer 202 is asynchronously reflected in the memory table 203.

The memory table 203 is a space that is synchronized with the memory table 103 of the active node 10, and holds identical record data. For example, the memory table 203 holds the committed process-completion data. A record stored in the memory table 203 also has the data structure 113 in the same manner as the data structure of the record in the memory table 103 of the active node 10 illustrated in FIG. 6. In a case where the standby node 20 is switched to an active node 10, the memory table 203 functions as the memory table 103 of the active node 10.

After processing for a batch process request by the active node 10 is completed, the storage processing unit 204 receives transmission data for mirroring including mirror data of a process result of each API included in the batch process request from the synchronization processing unit 107. Meanwhile, mirror data of the already transmitted process result among the process results of the respective APIs included in the batch process request is not included in the transmission data for mirroring. After processing for a process request including a reference request by the active node 10 is completed, the storage processing unit 204 receives, from the synchronization processing unit 107, transmission data for mirroring in which mirror data for each un-transmitted log with equal to or lower than the maximum transmission number and for each commit log of the process request are collected.

The storage processing unit 204 checks the temporary space flag of each mirror data included in the received transmission data for mirroring. In a case where the mirror data has the temporary space flag of ON, the storage processing unit 204 stores, as a log, information included in the mirror data in the temporary storage space 201. By contrast, in a case where the mirror data has the temporary space flag of OFF, the storage processing unit 204 stores information included in the mirror data as a record in the mirroring buffer 202.

In a case where a notification of a commit of an update difference of the batch process request is received, the storage processing unit 204 stores a record including the information of the log in the temporary storage space 201 in the mirroring buffer 202 to reflect the update difference. The storage processing unit 204 deletes the log in the temporary storage space 201.

After the storage of all the mirror data included in the transmission data for mirroring is completed, the storage processing unit 204 transmits a reception response to the synchronization processing unit 107 of the active node 10. After that, when a predetermined timing is reached, the storage processing unit 204 stores all pieces of information of the records in the mirroring buffer 202 in the memory table 203 to reflect the update difference.

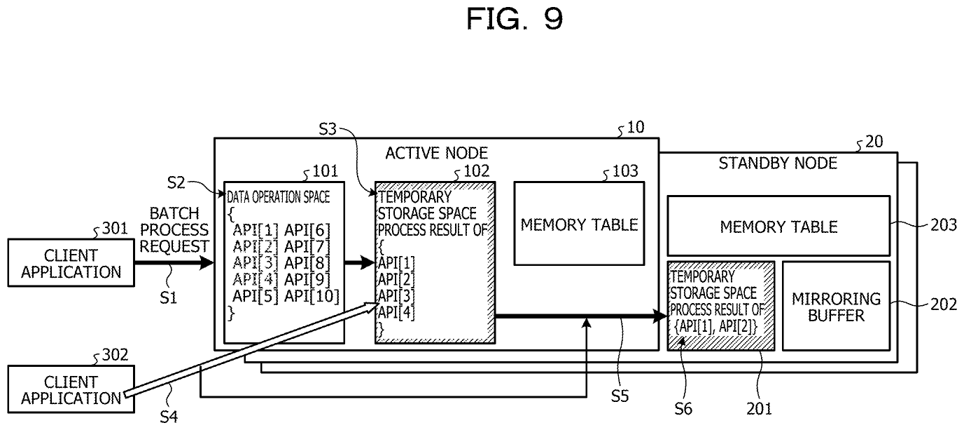

FIG. 9 is a diagram illustrating an overview of an operation in a case where process-completion data stored in a temporary storage space is referred to. Next, an operation in a case where process-completion data stored in the temporary storage space 102 in the cluster system 1 according to the present embodiment is referred to will be collectively described with reference to FIG. 9. Here, a case where two client applications 301 and 302 exist will be described.

The client application 301 transmits a batch process request to the active node 10 (step S1). By processing the batch process request, the number of times of synchronization with the standby node 20 may be reduced as compared with a case where the active node 10 individually processes each API.

The API processing unit 105 of the active node 10 starts processing for the batch process request from the client application 301. For example, in a case where-processing for an API[1] to an API[10] among APIs included in the request list 11 are performed, the API processing unit 105 stores data related to the processing for the API[1] to the API[10] in the data operation space 101 (step S2). When the processing for the API[1] to the API[4] are completed, the temporary storage processing unit 106 stores logs of process results of the API[1] to the API[4] in the temporary storage space 102 (step S3).

The logs of the process results of the API[1] to the API[4] stored in the temporary storage space 102 are treated as committed logs, and may be referred to by the client application 302 other than the client application 301 that has issued the batch process request. For example, by associating the log stored in the temporary storage space 102 with a corresponding record in the memory table 103 by using a pointer to the temporary storage space 102, the client application 301 may refer to a new state in the temporary storage space 102 based on the pointer. By accumulating process-completion data in the temporary storage space 102 in this manner, the client application 302 may refer to the process-completion data without waiting for process completion of the batch process request, and a processing speed may be increased.

At this point, when the active node 10 receives a process request including a reference request to the process-completion data by the API[2] from the client application 302, the API processing unit 105 refers to the log of the API[2] in accordance with the reference request (step S4).

After the log of the API[2] is referred to, the synchronization processing unit 107 generates transmission data for mirroring in which mirror data including the process results of the API[1] and the API[2] having a temporary storage number equal to or lower than the API[2] and yet to be transmitted to the standby node 20 is summarized. The synchronization processing unit 107 transmits the generated transmission data for mirroring to the standby node 20 (step S5).

As described above, when the client application 302 refers to the process-completion data in the temporary storage space 102, the active node 10 transmits the log of the previous process result including the referred process-completion data to the standby node 20. Accordingly, it is possible to avoid a data loss when the active node 10 shuts down, due to the fact that the data referred to by the client application 302 does not exist in the standby node 20. By collectively transmitting and synchronizing the process results before the referred process-completion data to the standby node 20, it is possible to keep an order of the process results of the APIs included in the batch process request.

As a transmission timing of the transmission data for mirroring, the active node 10 transmits the transmission data at a time of commit an update difference in response to a process request from the client application 302. At this time, the active node 10 determines whether or not the data of each log has been transmitted to the standby node 20, based on a transmission-completion flag of the log stored in the temporary storage space 102. By transmitting a process result of the process-completion data referred to and process results of the process-completion data therebefore to the standby node 20 at the same timing as the commit of the process request from the client application 302, the active node 10 may increase the processing speed of the cluster system 1 without increasing the number of times of transmission.

The logs of the process results of the API[1] and the API[2] are stored in the temporary storage space 201 of the standby node 20 (step S6). The standby node 20 uses the temporary space flag of the transmitted mirror data to determine whether the mirror data is to be stored in the temporary storage space 201 or the mirroring buffer 202. The process result of the API stored in the temporary storage space 201 may be used as it is when the batch process request is re-processed when switching occurs, and the new active node 10 may process an API subsequent to the API stored in the temporary storage space 201.

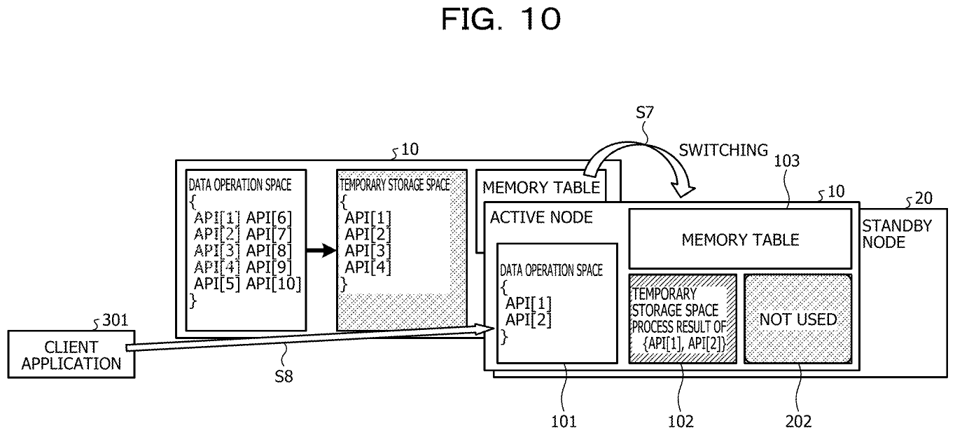

FIG. 10 is a diagram illustrating an overview of an operation in a case where switching of an active node occurs during execution of processing for a batch process request. Next, an operation in a case where switching of the active node 10 occurs during execution of processing for a batch process request in the cluster system 1 according to the present embodiment will be collectively described with reference to FIG. 10.

In the state illustrated in FIG. 9, the active node 10 shuts down, and switching of the active node 10 occurs (step S7). In this case, the temporary storage space 201 of the switched standby node 20 becomes the temporary storage space 102 of the new active node 10. For example, in a state immediately after the switching, the logs of the process results of the API[1] and the API[2] exist in the temporary storage space 102 of the new active node 10 after the switching. The memory table 203 of the switched standby node 20 is changed to the memory table 103 of the new active node 10. Meanwhile, the mirroring buffer 202 of the standby node 20 after the switching is not used after the switching.

Since the processing for the transmitted batch process request is not completed, the client application 301 requests re-processing for the batch process request (step S8).

When receiving the re-request for the batch process request, the new active node 10 starts processing from an API at a head. At this time, in the active node 10, the process results of the API[1] and the API[2] are already stored in the temporary storage space 102 as logs. Thus, the active node 10 does not store the process results of the API[1] and the API[2] in the data operation space 101. The active node 10 starts actual processing from the API[3].

As described above, by transmitting the process result to the temporary storage space 201 of the standby node 20, the new active node 10 after the switching may skip processing for an API in which a process result is stored by comparing the data, and may process the batch process request while avoiding duplicate processing. As described above, since the batch process request is processed while avoiding the duplicate processing in the new active node 10, the client application 301 may request re-processing for the batch process request without worrying about a process state.

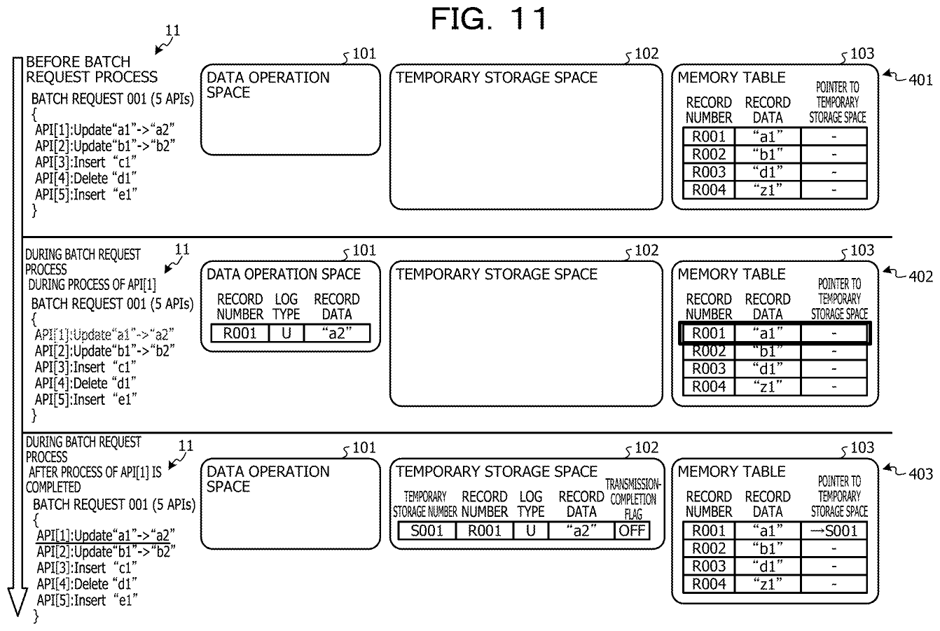

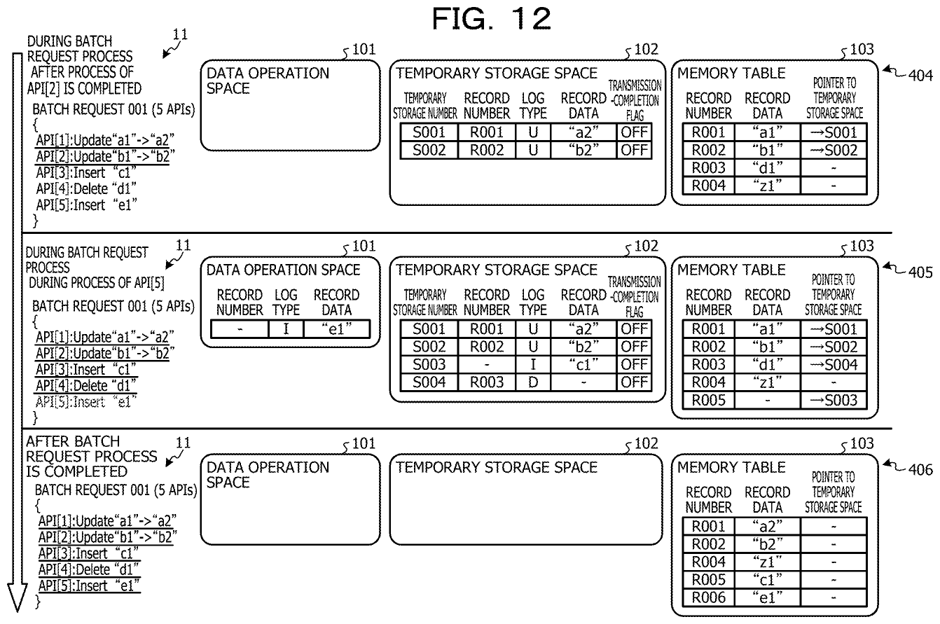

Next, an example of a transition of a state of the active node 10 when a batch process request is processed will be described. FIG. 11 is a first diagram illustrating a transition of data held in an active node when a batch process request is processed. FIG. 12 is a second diagram illustrating the transition of the data held in the active node when the batch process request is processed. States of the data operation space 101, the temporary storage space 102, and the memory table 103 sequentially transition in time-series from a first state 401 in FIG. 11 to a last state 406 in FIG. 12.

The state 401 indicates a state before the active node 10 processes the batch process request. In this case, since the batch process request is not yet processed, nothing is stored in the data operation space 101 and the temporary storage space 102. Records with record numbers R001 to R004 are stored in the memory table 103. Meanwhile, the pointer to temporary storage space of each record in the memory table 103 is in an initial state. The active node 10 starts processing for a batch process request including the request list 11. The request list 11 includes process commands of the API[1] to the API[5].

Immediately before-processing for the API[1] in the batch process request is completed, the active node 10 transitions to a state 402. The API processing unit 105 registers a process result of the API[1] in the data operation space 101 as a commit log. By the processing for the API[1], the API processing unit 105 rewrites “a1”, which is record data of the record number R001 stored in the memory table 103, to “a2”.

After the processing for the API[1] is completed, the active node 10 transitions to the state 403. In FIGS. 11 and 12, the process completion of the API in the request list 11 is represented by an underline. The temporary storage processing unit 106 stores a log including information on a commit log of the process result of the API[1] in the data operation space 101 in the temporary storage space 102, and deletes the commit log from the data operation space 101. At this time, the temporary storage processing unit 106 allocates S001 as a temporary storage number corresponding to an index of the API[1] in the request list 11, and sets a transmission-completion flag to OFF. Here, the temporary storage processing unit 106 associates a number in brackets of the API in the request list with the lowest number of the temporary storage number. The temporary storage processing unit 106 registers S001, which is a temporary storage number of a log of the record number R001 in the temporary storage space 102, as the pointer to temporary storage space of a record of the record number R001 registered in the memory table 103.

Next, after processing for the API[2] in the batch process request is completed, the active node 10 transitions to a state 404 in FIG. 12. By performing the processing for the API[2], the API processing unit 105 rewrites “b1”, which is record data of a record number R002 stored in the memory table 103, to “b2”. The temporary storage processing unit 106 stores a log in which a record number of the process result of the API[2] is R002 in the temporary storage space 102. At this time, the temporary storage processing unit 106 allocates S002 as a temporary storage number corresponding to an index of the API[2] in the request list 11, and sets a transmission-completion flag to OFF. The temporary storage processing unit 106 registers S002, which is a temporary storage number of a log of the record number R002 in the temporary storage space 102, as the pointer to temporary storage space of a record of the record number R002 registered in the memory table 103.

During processing for the last API[5] in the request list 11, the active node 10 transitions to a state 405. By this time, the API processing unit 105 newly inserts “c1” as record data by processing for the API[3], and further deletes “d1”, which is record data with a record number R003 registered in the memory table 103, by processing for the API[4]. Accordingly, the temporary storage processing unit 106 stores logs of temporary storage numbers S003 and S004 indicated in the state 405 in the temporary storage space 102, and registers a pointer to temporary storage space in which the record number stored in the memory table 103 is R003. The API processing unit 105 registers a process result of the API[5] in the data operation space 101 as a commit log. By the processing for the API[5], the API processing unit 105 inserts “e1”, which is new record data.

After the processing for the last API[5] in the batch process request is completed, the active node 10 transitions to the state 406. The synchronization processing unit 107 generates transmission data including each mirror data of a commit log of the API[5] stored in the data operation space 101 and the logs of the API[1] to the API[4] stored in the temporary storage space 102. The synchronization processing unit 107 transmits the generated transmission data to the standby node 20 to perform mirroring. After that, upon receiving the reception response, the synchronization processing unit 107 stores a record including information on the commit log in the data operation space 101 and the log in the temporary storage space 102 in the memory table 103 to reflect an update difference in the memory table 103. The synchronization processing unit 107 initializes the pointer to temporary storage space of the memory table 103, and deletes the commit log of the data operation space 101 and the log of the temporary storage space 102.

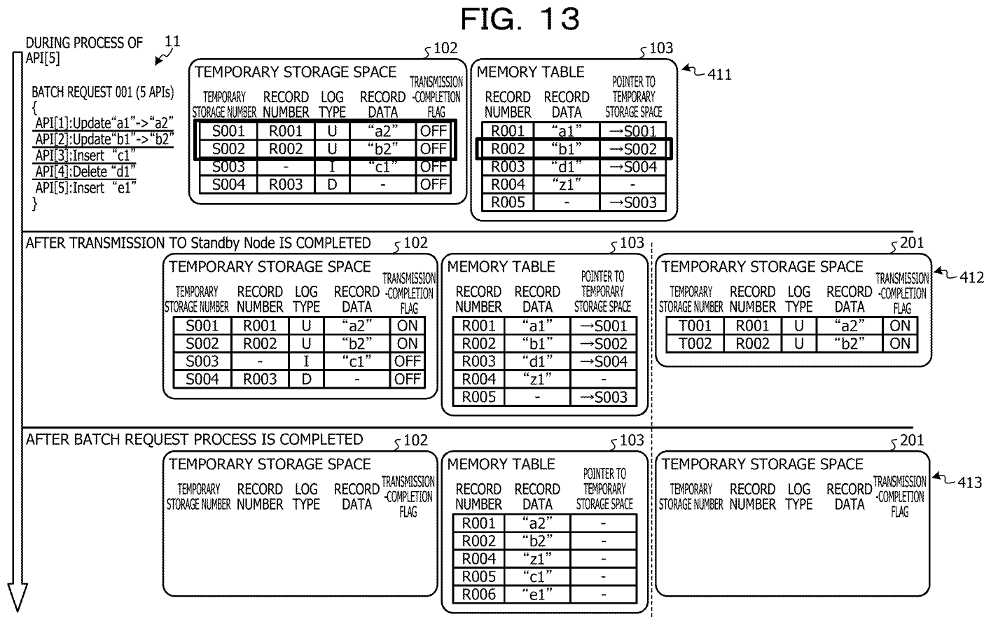

Next, an example of a transition of states of the active node 10 and the standby node 20 in a case where process-completion data is referred to from another client application 300 during processing for a batch process request will be described. FIG. 13 is a diagram illustrating an example of a transition of states of an active node and a standby node in a case where reference is made during the processing for the batch process request. Here, a case where process-completion data, which is the process result of the API[2], is referred to by a process request from the another client application 300 in a case of the state 405 in FIG. 12 will be described.

In the case of the state 405 in FIG. 12, when the process-completion data, which is the process result of the API[2], is referred to by the process request from the another client application 300, the active node 10 transitions to a state 411. According to the reference request, the API processing unit 105 refers to the record with the record number R002 in the memory table 103. Accordingly, since the S002 is registered as the pointer to temporary storage space, the API processing unit 105 refers to a log in which a temporary storage number in the temporary storage space 102 is S002, and acquires “b2” registered as the record data.

The API processing unit 105 determines whether or not a temporary storage number of the referred record is larger than a value of a maximum transmission number stored in the API processing unit 105. In this case, since this reference is a first reference, the API processing unit 105 sets S002, which is a temporary storage number of the log of the process result of the referenced API[2], as the maximum transmission number. The API processing unit 105 instructs the synchronization processing unit 107 to transmit the log having a temporary storage number equal to or lower than the S002. The temporary storage number equal to or lower than S002 is a temporary storage number of a log including a process result of processing for an API before the processing corresponding to the process result stored in the log having the temporary storage number of S002. For example, the synchronization processing unit 107 transmits, to the standby node 20, the logs of the process results of the API[1] and the API[2] each having a temporary storage number equal to or lower than S002 and a transmission-completion flag of OFF.

After the logs of the process results of the API[1] and the API[2] are transmitted to the standby node 20, the active node 10 and the standby node 20 transition to the state 412. For example, the synchronization processing unit 107 sets a transmission-completion flag of the logs having the temporary storage numbers of S001 and S002 in the temporary storage space 102, to ON. The storage processing unit 204 of the standby node 20 stores the logs of the process results of the API[1] and the API[2] in the temporary storage space 201.

After that, when all the processing for the batch process request are completed, the active node 10 and the standby node 20 transition to the state 413. For example, the synchronization processing unit 107 stores a record including information on all logs in the temporary storage space 102 in the memory table 103, reflects the update difference, and deletes all logs in the temporary storage space 102. The synchronization processing unit 107 initializes the pointer to temporary storage space. The storage processing unit 204 of the standby node 20 stores a record including information of each log stored in the temporary storage space 201 in the mirroring buffer 202, reflects the update difference, and deletes all the logs stored in the temporary storage space 201.

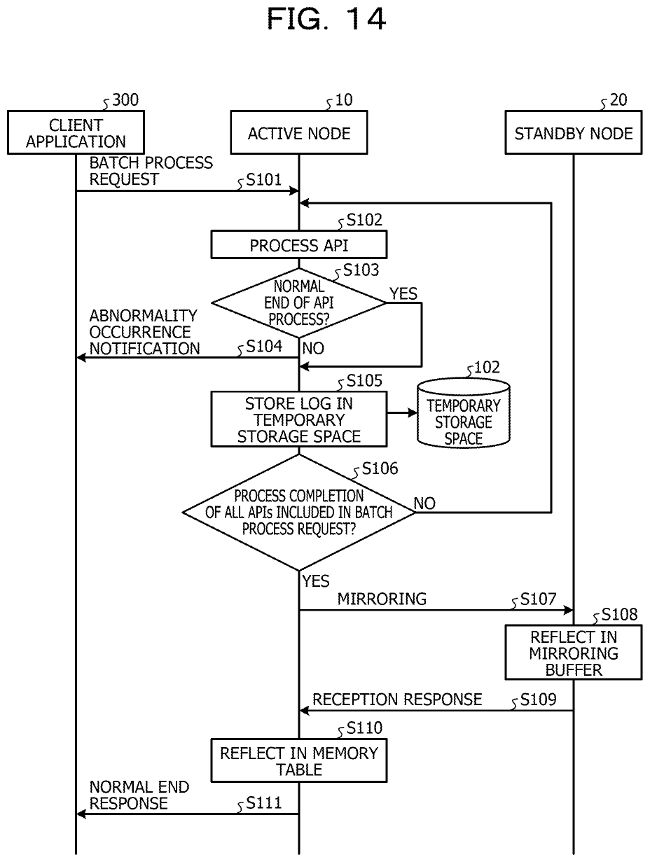

FIG. 14 is a sequence diagram illustrating an operation of a cluster system in a case where a reference is not performed during processing for a batch process request. Next, an operation of the cluster system 1 in a case where a reference is not performed from another client application 300 while a batch process request is being processed will be described with reference to FIG. 14.

The client application 300 transmits a batch process request to the active node 10 (step S101).

The API processing unit 105 of the active node 10 acquires the batch process request from the communication unit 104. By using the data operation space 101, the API processing unit 105 sequentially performs processing for each API included in the batch process request (step S102). After the processing for each API, the API processing unit 105 determines whether or not the processing for the API is normally ended (step S103).

In a case where the processing for the API is not normally ended (No in step S103), the API processing unit 105 transmits a notification of the abnormality occurrence to the client application 300, and returns to the processing with the client application 300 (step S104).

By contrast, in a case where the processing for the API is normally ended (Yes in step S103), the temporary storage processing unit 106 stores information on a process result of the API included in a commit log in the data operation space 101, in the temporary storage space 102 as a log (step S105).

Next, the API processing unit 105 determines whether or not the processing for all the APIs included in the batch process request are completed (step S106). In a case where an API which is not processed remains (No in step S106), the API processing unit 105 returns to step S102.

By contrast, in a case where the processing for all the APIs included in the batch process request are completed (Yes in step S106), the synchronization processing unit 107 uses the logs stored in the temporary storage space 102 to create each mirror data of the logs. In this case, the synchronization processing unit 107 sets the temporary space flag to OFF in all the mirror data. After that, the synchronization processing unit 107 transmits transmission data for mirroring storing the created mirror data to the standby node 20 to perform mirroring (step S107).

The storage processing unit 204 of the standby node 20 acquires the transmission data, checks that the temporary space flag is OFF, stores information on the process results of all the API included in the mirror data as a record in the mirroring buffer 202 to reflect an update difference (step S108).

After that, the storage processing unit 204 transmits a reception response to the transmission data for mirroring to the active node 10 (step S109).

After receiving the reception response, the synchronization processing unit 107 of the active node 10 stores a plurality of records including information of each log stored in the temporary storage space 102 in the memory table 103 to reflect the update difference (step S110). The synchronization processing unit 107 deletes the log stored in the temporary storage space 102.

After that, the API processing unit 105 receives a notification of the reflection completion of the update difference from the synchronization processing unit 107, transmits a normal end response to the client application 300, and returns to the processing with the client application 300 (step S111).

As described above, in a case where the processing for the API is not normally ended, the active node 10 notifies the client application 300 of an abnormality occurrence notification, and in the following description, a case where an abnormality occurs will be omitted.

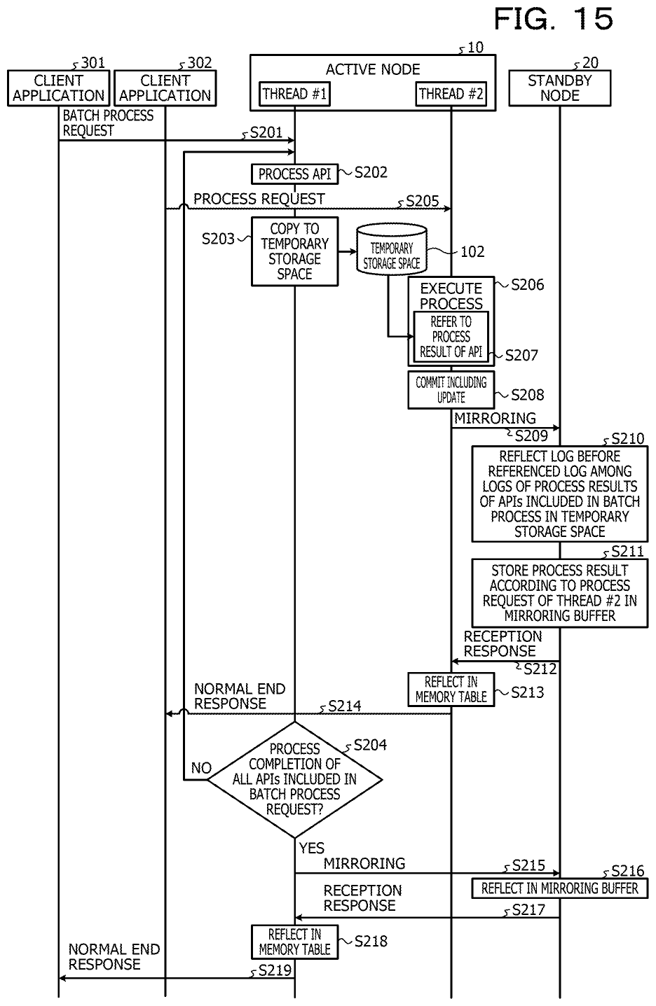

FIG. 15 is a sequence diagram illustrating an operation of the cluster system in a case where a reference is performed during processing for a batch process request. Next, an operation of the cluster system 1 in a case where a reference is performed from another client application 300 while the batch process request is being processed will be described with reference to FIG. 15. Here, a case where the client applications 301 and 302 exist and the active node 10 processes a process request from each of the client applications 301 and 302, as threads #1 and #2 will be described.

The client application 301 transmits a batch process request to the active node 10 (step S201).

The API processing unit 105 of the active node 10 acquires the batch process request from the communication unit 104. In the thread #1, the API processing unit 105 sequentially performs processing for each API included in the batch process request by using the data operation space 101 (step S202).

After the processing for one API is ended in the thread #1, the temporary storage processing unit 106 stores information on a process result of the API, which is included in a commit log in the data operation space 101, in the temporary storage space 102 as a log (step S203).

Next, the API processing unit 105 determines whether or not the processing for all the APIs included in the batch process request are completed in the thread #1 (step S204). In a case where an API which is not processed remains (No in step S204), the API processing unit 105 returns to step S202.

By contrast, in a case where the processing for all the APIs included in the batch process request are completed (Yes in step S204), the processing in the thread #1 proceeds to step S215.

While the API processing unit 105 is processing the batch process request in the thread #1, the client application 302 transmits a process request including a reference request to the active node 10 (step S205).

The API processing unit 105 of the active node 10 acquires the process request from the communication unit 104. By using the data operation space 101, the API processing unit 105 performs processing for an API included in the process request in the thread #2 (step S206). According to the reference request in the process request, the API processing unit 105 refers to the log of the process result of the API stored in the temporary storage space 102 (step S207).

After that, when the processing for the process request in the thread #2 is completed, the API processing unit 105 sets a temporary storage number of the referred log as a maximum transmission number when the temporary storage number of the referred log is larger than a value of the maximum transmission number. The API processing unit 105 notifies the synchronization processing unit 107 of an instruction to transmit an un-transmitted log having a value equal to or lower than the value of the maximum transmission number and the process completion of the process request in the thread #2. When receiving the notification, the synchronization processing unit 107 executes a commit including an update (step S208). For example, the synchronization processing unit 107 acquires the un-transmitted log with equal to or lower than the maximum transmission number stored in the temporary storage space 102 and the commit log of the process result of the API of the process request in the thread #2 stored in the data operation space 101. The synchronization processing unit 107 generates each mirror data. At this time, the synchronization processing unit 107 sets the temporary space flag of the mirror data of the un-transmitted log with equal to or lower than the maximum transmission number stored in the temporary storage space 102, to ON. The synchronization processing unit 107 sets the temporary space flag of the mirror data of the commit log of the process result of the API of the process request in the thread #2, to OFF. The synchronization processing unit 107 transmits transmission data for mirroring that stores the created mirror data to the standby node 20 to perform mirroring (step S209).

The storage processing unit 204 of the standby node 20 stores, in the temporary storage space 201, a process result of an API included in mirror data in which the temporary space flag is ON among the mirror data included in the transmission data for mirroring. For example, the storage processing unit 204 stores the referenced log and logs therebefore among the logs of the process results of the APIs included in the batch process, which are stored in the temporary storage space 102 of the active node 10, in the temporary storage space 201 of the standby node 20 to reflect an update difference (step S210).

The storage processing unit 204 stores, in the mirroring buffer 202, a record including a process result of an API included in mirror data in which the temporary space flag is OFF among the mirror data included in the transmission data for mirroring. For example, the storage processing unit 204 stores a record including the process result of the API of the process request in the thread #2 in the mirroring buffer 202 to reflect the update difference (step S211).

After that, the storage processing unit 204 transmits a reception response to the transmission data for mirroring for the thread #2 to the active node 10 (step S212).

After receiving the reception response to the thread #2, the synchronization processing unit 107 of the active node 10 stores, in the memory table 103, a record including information on the process result of the API included in the commit log stored in the data operation space 101 of the thread #2 to reflect the update difference (step S213).

After that, the API processing unit 105 receives a notification of the reflection completion of the update difference in the thread #2 from the synchronization processing unit 107. The API processing unit 105 transmits a normal end response to the client application 302, and returns to the processing with the client application 302 (step S214).

By contrast, in the thread #1, the synchronization processing unit 107 creates mirror data of each log having the transmission-completion flag of OFF, among the commit log of the process result of the last API existing in the data operation space 101 and the logs stored in the temporary storage space 102. In this case, the synchronization processing unit 107 sets the temporary space flags of all the mirror data to OFF. After that, in the thread #1, the synchronization processing unit 107 transmits the transmission data for mirroring storing the created mirror data to the standby node 20 to perform mirroring (step S215).

The storage processing unit 204 of the standby node 20 acquires the transmission data, and checks that the temporary space flags of all mirror data are OFF. The storage processing unit 204 stores information on the process results of all the APIs included in the mirror data as a record and information on the log stored in the temporary storage space 201 as a record in the mirroring buffer 202 to reflect the update difference (step S216).

After that, the storage processing unit 204 transmits a reception response to the transmission data for mirroring for the thread #1 to the active node 10 (step S217).

The synchronization processing unit 107 of the active node 10 receives the reception response for the thread #1. The synchronization processing unit 107 stores a plurality of records including information on each log stored in the temporary storage space 102 in the memory table 103 to reflect the update difference (step S218). The synchronization processing unit 107 deletes the log stored in the temporary storage space 102.

After that, the API processing unit 105 receives a notification of the reflection completion of the update difference in the thread #1 from the synchronization processing unit 107. The API processing unit 105 transmits a normal end response to the client application 301, and returns to the processing with the client application 301 (step S219).

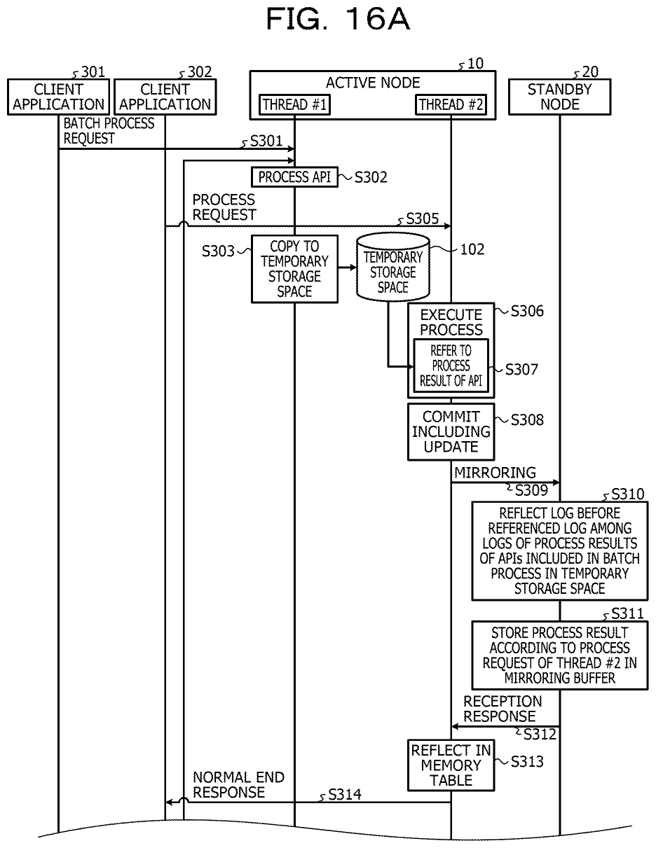

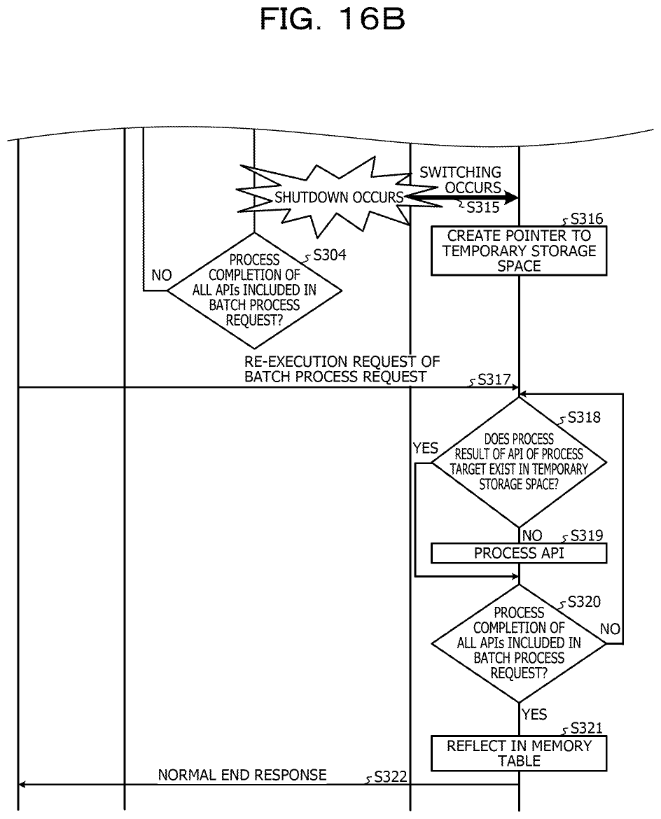

FIGS. 16A and 16B are sequence diagrams illustrating an operation of the cluster system in a case where a reference is performed during processing for a batch process request and switching occurs. Next, an operation of the cluster system 1 in a case where a reference is performed from another client application 300 during processing for a batch process request and switching of the active node 10 occurs will be described with reference to FIGS. 16A and 16B. Here, a case where the client applications 301 and 302 exist and the active node 10 processes a process request from each of the client applications 301 and 302, as threads #1 and #2 will be described.

The client application 301 transmits a batch process request to the active node 10 (step S301).

The API processing unit 105 of the active node 10 acquires the batch process request from the communication unit 104. In the thread #1, the API processing unit 105 sequentially performs processing for each API included in the batch process request by using the data operation space 101 (step S302).

After the processing for one API is ended in the thread #1, the temporary storage processing unit 106 stores information on a process result of the API, which is included in a commit log in the data operation space 101, in the temporary storage space 102 as a log (step S303).

Next, the API processing unit 105 determines whether or not the processing for all the APIs included in the batch process request are completed in the thread #1 (step S304). In a case where an API which is not processed remains (No in step S304), the API processing unit 105 returns to step S302. Here, since the active node 10 shuts down before the processing for all the APIs included in the batch process request are completed, a branch to a case where the processing for all the APIs included in the batch process request are completed does not occur, and thus the processing does not proceed in the branch direction.

While the API processing unit 105 is processing the batch process request in the thread #1, the client application 302 transmits a process request including a reference request to the active node 10 (step S305).

The API processing unit 105 of the active node 10 acquires the process request from the communication unit 104. By using the data operation space 101, the API processing unit 105 performs processing for an API included in the process request in the thread #2 (step S306). According to the reference request in the process request, the API processing unit 105 refers to the log of the process result of the API stored in the temporary storage space 102 (step S307).

After that, when the processing for the process request in the thread #2 is completed, the API processing unit 105 sets a temporary storage number of the referred log as a maximum transmission number when the temporary storage number of the referred log is larger than a value of the maximum transmission number. The API processing unit 105 notifies the synchronization processing unit 107 of an instruction to transmit an un-transmitted log having a value equal to or lower than the value of the maximum transmission number and the process completion of the process request in the thread #2. When receiving the notification, the synchronization processing unit 107 executes a commit including an update (step S308). The synchronization processing unit 107 transmits transmission data for mirroring to the standby node 20 to perform mirroring (step S309).

The storage processing unit 204 of the standby node 20 stores, in the temporary storage space 201, a process result of an API included in mirror data in which the temporary space flag is ON among the mirror data included in the transmission data for mirroring. For example, the storage processing unit 204 stores the referenced log and logs therebefore among the logs of the process results of the APIs included in the batch process, which are stored in the temporary storage space 102 of the active node 10, in the temporary storage space 201 of the standby node 20 to reflect an update difference (step S310).

The storage processing unit 204 stores, in the mirroring buffer 202, a record including a process result of an API included in mirror data in which the temporary space flag is OFF among the mirror data included in the transmission data for mirroring. For example, the storage processing unit 204 stores a record including the process result of the API of the process request in the thread #2 in the mirroring buffer 202 to reflect the update difference (step S311).

After that, the storage processing unit 204 transmits a reception response to the transmission data for mirroring for the thread #2 to the active node 10 (step S312).

The synchronization processing unit 107 of the active node 10 receives the reception response for the thread #2. The synchronization processing unit 107 stores, in the memory table 103, a record including information on the process result of the API included in the commit log stored in the data operation space 101 for the thread #2 to reflect the update difference (step S313).

After that, the API processing unit 105 receives a notification of the reflection completion of the update difference in the thread #2 from the synchronization processing unit 107. The API processing unit 105 transmits a normal end response to the client application 302, and returns to the processing with the client application 302 (step S314).

After that, during the processing for the batch process request in the thread #1, the active node 10 shuts down, switching of the active node 10 occurs, and the standby node 20 becomes the new active node 10 (step S315). For convenience of illustration, the standby node 20 is illustrated as it is in FIGS. 16A and 16B. Hereinafter, the standby node 20 will be described as the new active node 10.

When the switching occurs, the temporary storage processing unit 106 of the new active node 10 creates a pointer to the temporary storage space 201, and registers the pointer as the pointer to temporary storage space of each record in the memory table 103 (step S316).

The client application 301 transmits a re-request for the batch process request to the new active node 10 to request re-processing (step S317).

When receiving the re-request for the batch process request, the API processing unit 105 of the new active node 10 sequentially starts the processing for the API included in the batch process request. The API processing unit 105 determines whether or not a log of a process result of an API as a process target exists in the temporary storage space 102 (step S318). In a case where the log of the process result of the API as a process target exists in the temporary storage space 102 (Yes in step S318), the API processing unit 105 proceeds to step S320.

By contrast, in a case where the log of the process result of the API as a process target does not exist in the temporary storage space 102 (No in step S318), the API processing unit 105 performs processing for the API as a process target (step S319). In this case, when the API as a process target is not the last API, the temporary storage processing unit 106 stores the process result of the API as a log in the temporary storage space 102.

After that, the API processing unit 105 determines whether the processing for all the APIs included in the batch process request are completed (in step S320). In a case where an unprocessed API remains (No in step S320), the API processing unit 105 returns to step S318.

By contrast, in a case where the processing for all the APIs included in the batch process request are completed (Yes in step S320), the synchronization processing unit 107 stores a record including information on the log stored in the temporary storage space 102 in the memory table 103 to reflect the update difference (step S321). The synchronization processing unit 107 deletes the log stored in the temporary storage space 102.

After that, the API processing unit 105 receives a notification of the reflection completion of the update difference in the thread #1 from the synchronization processing unit 107. The API processing unit 105 transmits a normal end response to the client application 301, and returns to the processing with the client application 301 (step S322).

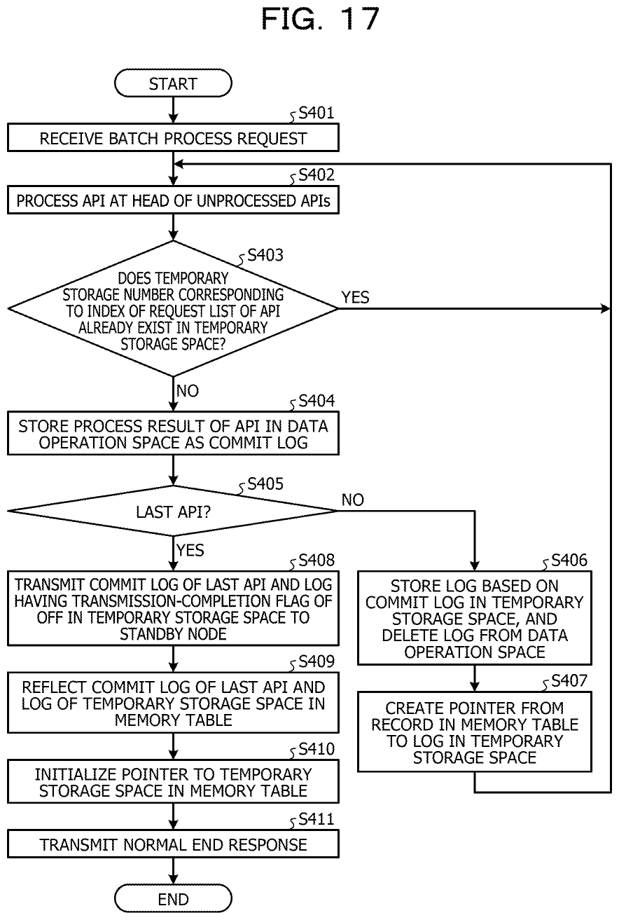

FIG. 17 is a flowchart illustrating processing by an active node when a batch process request is received. Next, a flow of processing by the active node 10 when a batch process request is received will be described with reference to FIG. 17.

Via the communication unit 104, the API processing unit 105 receives the batch process request transmitted from the client application 300 (step S401).

Next, the API processing unit 105 starts processing for an API at a head of unprocessed APIs among the APIs included in the batch process request (step S402).

Next, the API processing unit 105 determines whether or not a temporary storage number corresponding to an index of a request list of the API as a process target already exists in the temporary storage space 102 (step S403). In a case where the temporary storage number corresponding to the index of the request list of the API as a process target already exists in the temporary storage space 102 (Yes in step S403), the API processing unit 105 returns to step S402.

By contrast, in a case where the temporary storage number corresponding to the index of the request list of the API as a process target does not exist in the temporary storage space 102 (No in step S403), the API processing unit 105 processes the API by using the data operation space 101. The API processing unit 105 stores a process result of the API in the data operation space 101 as a commit log (step S404).

The API processing unit 105 determines whether or not the processed API is the last API among the APIs included in the batch process request (step S405). In a case where the processed API is not the last API (No in step S405), the temporary storage processing unit 106 stores information on the process result of the API, which is included in the commit log, in the temporary storage space 102 as a log, and deletes the commit log from the data operation space 101 (step S406).

The temporary storage processing unit 106 creates a pointer from a record of the memory table 103 to the stored log of the temporary storage space 102, and registers the pointer as the pointer to temporary storage space of the memory table 103 (step S407). After that, the API processing unit 105 returns to step S402.

By contrast, in a case where the processed API is the last API of the batch process request (Yes in step S405), the synchronization processing unit 107 transmits, to the standby node 20, the commit log of the last API and logs, in which the transmission-completion flag is OFF, in the temporary storage space 102. For example, the synchronization processing unit 107 generates each mirror data, and transmits the transmission data for mirroring including the generated mirror data to the standby node 20 (step S408).

After that, when a reception response is received, the synchronization processing unit 107 stores a plurality of records, which include information on the process result of the API included in each of the commit log of the last API and the logs of the temporary storage space, in the memory table 103 to reflect an update result (step S409).

After that, the synchronization processing unit 107 initializes the pointer to temporary storage space in the memory table 103 (step S410).

After that, the API processing unit 105 transmits a normal end response to the client application 300 via the communication unit 104 (step S411).

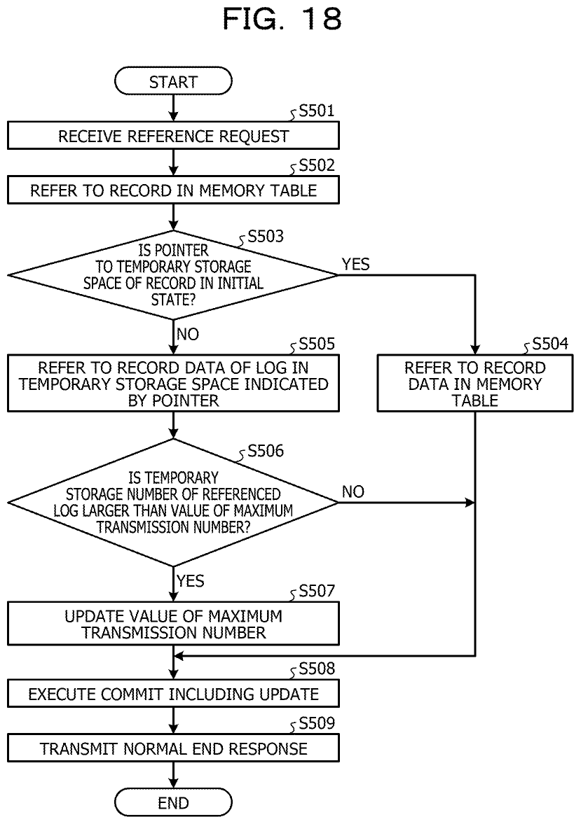

FIG. 18 is a flowchart illustrating processing by an active node when a reference request is received. Next, a flow of processing by the active node 10 when a reference request is received will be described with reference to FIG. 18.

The API processing unit 105 receives the reference request transmitted from the client application 300 via the communication unit 104 (step S501).

Next, the API processing unit 105 refers to a record in the memory table 103 designated by the reference request (step S502).

The API processing unit 105 determines whether or not the pointer to temporary storage space of the referred record is in an initial state (step S503).

In a case where the pointer to temporary storage space of the referenced record is in the initial state (Yes in step S503), the API processing unit 105 refers to the record data of the memory table 103 (step S504). After that, the processing by the active node 10 proceeds to step S508.

By contrast, in a case where the pointer to temporary storage space of the referenced record is not in the initial state (No in step S503), the API processing unit 105 references record data of a log in the temporary storage space 102 indicated by the pointer (step S505).

Next, the API processing unit 105 determines whether or not a temporary storage number of the referenced log is larger than a value of a maximum transmission number held by the API processing unit 105 (step S506). In a case where the temporary storage number of the referenced log is equal to or lower than the value of the maximum transmission number (No in step S506), the processing by the active node 10 proceeds to step S508.

By contrast, in a case where the temporary storage number is larger than the value of the maximum transmission number (Yes in step S506), the API processing unit 105 updates the value of the maximum transmission number to the temporary storage number of the referenced log (step S507).

After that, the synchronization processing unit 107 executes a commit including an update (step S508). For example, in a case where the log in the temporary storage space 102 is not referred to, the synchronization processing unit 107 transmits a commit log stored in the data operation space 101 to the standby node 20 to perform mirroring. In a case where the log of the temporary storage space 102 is referred to, the synchronization processing unit 107 transmits an un-transmitted log having the transmission number equal to or lower than the maximum transmission number stored in the temporary storage space 102 and the commit log of the data operation space 101 to the standby node 20 to perform mirroring.

After that, the API processing unit 105 transmits a normal response to the client application 300 via the communication unit 104 (step S509).

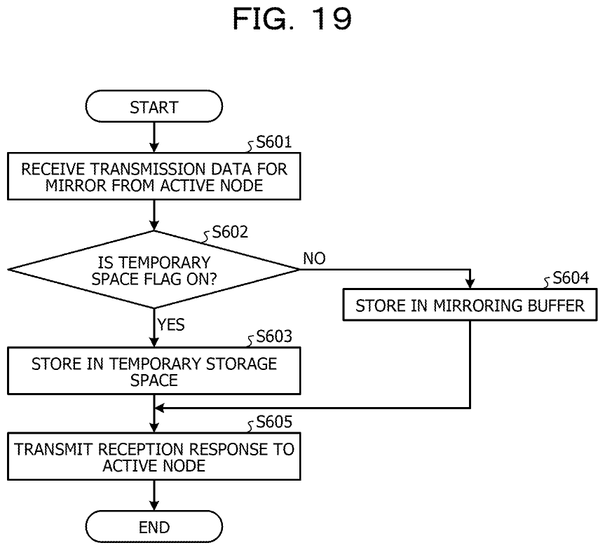

FIG. 19 is a flowchart of a reception process executed by a standby node. Next, a flow of a reception process by the standby node 20 will be described with reference to FIG. 19.

The storage processing unit 204 receives data from the active node 10 (step S601).

Next, the storage processing unit 204 determines whether or not the temporary space flag is ON (step S602).

In a case where the temporary space flag is ON (Yes in step S602), the storage processing unit 204 stores a log including information on a process result of an API in the temporary storage space 201 (step S603).

By contrast, in a case where the temporary space flag is OFF (No in step S602), the storage processing unit 204 stores a record including information on a process result of an API in the mirroring buffer 202 (step S604).

After that, the storage processing unit 204 transmits a response indicating reception of transmission data for mirroring to the active node 10 (step S605).

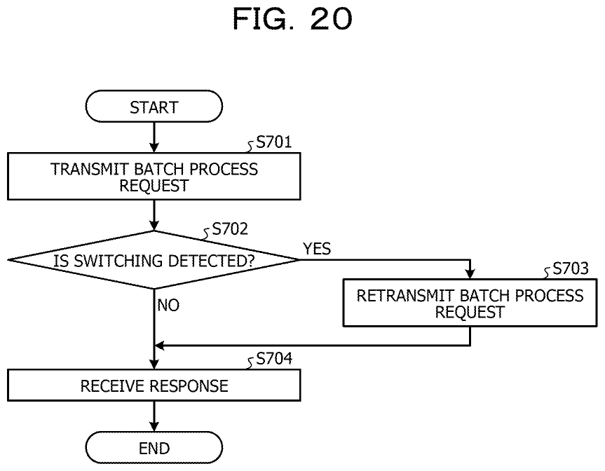

FIG. 20 is a flowchart of a transmission processing for a batch process request by a client application. Next, a flow of a transmission processing for a batch process request by the client application 300 will be described with reference to FIG. 20.

The client application 300 transmits the batch process request to the active node 10 to request processing (step S701).

After that, the client application 300 determines whether or not switching of the active node 10 is detected (step S702). In a case where the switching of the active node 10 is not detected (No in step S702), the client application 300 proceeds to step S704.

In a case where the switching of the active node 10 is detected (Yes in step S702), the client application 300 retransmits the batch process request to the new active node 10 to issue a re-request (step S703).

After that, the client application 300 receives the response to the transmitted batch process from the active node 10 (step S704). The client application 300 returns to communication with the active node 10.

As described above, in a case where an active node of a cluster system according to the present embodiment processes a batch process request, the active node stores a log in a temporary storage space every time processing for each API is completed. Accordingly, another client application may use process-completion data without waiting for completion of the entire batch process, and a processing speed of processing with a client may be increased. In a case where the log in the temporary storage space is referred to from the another client application, the active node transmits the referenced log and logs before the referenced log to a standby node. The standby node stores the received log in a temporary storage space. Accordingly, the standby node holds process-completion data before the process-completion data referred to by the another client application, and it is possible to avoid a data mismatch after the switching of the active node. By transmitting the previous log including the referenced log to the standby node at a timing of a commit of a process request including a reference request, an order of the process results of the APIs included in the batch process request may be maintained. As a result, it is possible to improve reliability of the system.

When a standby node is switched to an active node and receives the re-request for the batch process request, the standby node skips processing for an API for which a process result is already stored in the temporary storage space, and performs processing for an unprocessed API. Accordingly, in the re-processing of the batch process request, duplicate processing may be avoided, and efficiency of the processing for the batch process request may be improved. The client application may request the re-processing without worrying about a process state of the processing for the batch process request performed by the active node before the switching.

(Hardware Configuration)

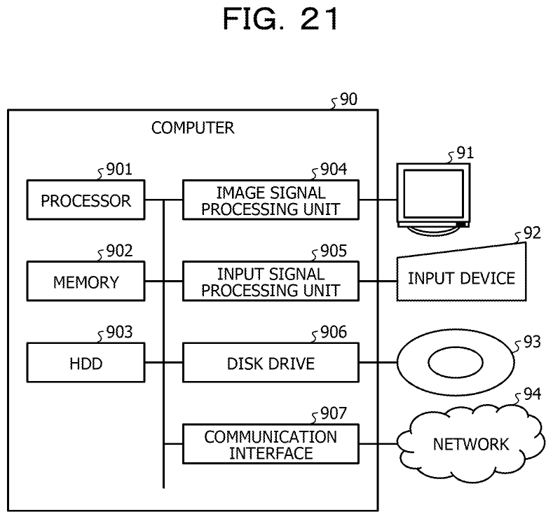

FIG. 21 is a diagram illustrating a hardware configuration of a computer. All of the active node 10, the standby node 20, and the terminal device 30 may be implemented by a computer 90 illustrated in FIG. 21.

As illustrated in FIG. 21, the computer 90 includes a processor 901, a memory 902, a hard disk drive (HDD) 903, an image signal processing unit 904, an input signal processing unit 905, a disk drive 906, and a communication interface 907. Each of the processor 901, the memory 902, the hard disk drive (HDD) 903, the image signal processing unit 904, the input signal processing unit 905, the disk drive 906, and the communication interface 907 is coupled to a bus, and may communicate with each other.

A display 91 is coupled to the image signal processing unit 904. When receiving an instruction from the processor 901, the image signal processing unit 904 causes the display 91 to display a message or an image. A user may check the message or the image displayed on the display 91.

An input device 92 such as a keyboard or a mouse is coupled to the input signal processing unit 905. The user may input a command by using the input device 92. The input signal processing unit 905 transfers the command input from the input device 92 to the processor 901.

The disk drive 906 is a device that reads and writes data from and to a storage medium 93. For example, the disk drive 906 may read a program stored in the storage medium 93, and transmit the program to the processor 901 to cause the processor 901 to execute the program.

The communication interface 907 is coupled to a network 94 such as a local area network (LAN) or a wide area network (WAN). The processor 901 may communicate with another apparatus coupled to the network 94 via the communication interface 907. For example, the communication interface 907 is used for communication between the active node 10 and the terminal device 30 and communication between the active node 10 and the standby node 20. For example, the communication interface 907 implements the function of the communication unit 104 illustrated in FIG. 3.

The HDD 903 is an auxiliary storage device. For example, in a case where the computer 90 is the active node 10, the HDD 903 implements the functions of the temporary storage space 102 and the memory table 103. The HDD 903 stores various programs including a program for implementing the functions of the API processing unit 105, the temporary storage processing unit 106, and the synchronization processing unit 107 illustrated in FIG. 3. In a case where the computer 90 is the standby node 20, the HDD 903 implements the functions of the temporary storage space 201, the mirroring buffer 202, and the memory table 203. The HDD 903 stores various programs including a program for implementing the function of the storage processing unit 204 illustrated in FIG. 3. In a case where the computer 90 is the terminal device 30, the HDD 903 stores various programs including a program for implementing the function of the client application 300.

The memory 902 is a main storage device. As the memory 902, for example, a dynamic random-access memory (DRAM) may be used. In a case where the computer 90 is the active node 10, the memory 902 implements the function of the data operation space 101 illustrated in FIG. 3.

The processor 901 reads various programs from the HDD 903, loads the programs into the memory 902, and executes the programs. Accordingly, in a case where the computer 90 is the active node 10, the processor 901 implements the functions of the API processing unit 105, the temporary storage processing unit 106, and the synchronization processing unit 107 illustrated in FIG. 3. In a case where the computer 90 is the standby node the processor 901 implements the function of the storage processing unit 204. In a case where the computer 90 is the terminal device 30, the processor 901 implements the function of the client application 300.

The program for implementing the function of each unit is not limited to being stored in the HDD 903, and may be stored in, for example, the detachable storage medium 93 and read by the processor 901 via the disk drive 906. Alternatively, the program for implementing the function of each unit may be stored in another computer coupled via the network 94. The program for implementing the function of each unit may be read by the processor 901 from another computer via the communication interface 907.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A data management system, comprising:
an operating-mode node; and
a standby-mode node,
wherein the operating-mode node includes:
a first memory that includes a temporary storage space; and
a first processor coupled to the first memory and the first processor configured to:
process a received process request;
in a case where the received process request is a batch process request which includes a plurality of process commands, sequentially execute each of the process commands included in the batch process request;
store process-completion data corresponding to each of the process commands in the temporary storage space every time the execution of each of the process commands is completed;
in a case where the process-completion data stored in the temporary storage space is referred to in processing for another process request, transmit predetermined process-completion data to the standby-mode node based on a reference state of the temporary storage space; and
when execution of all the process commands included in the batch process request is completed, transmit un-transmitted process-completion data, which is process-completion data not yet transmitted, to the standby-mode node to perform data synchronization.

2. The data management system according to claim 1, wherein the standby-mode node includes:
a second memory including:
a standby-mode temporary storage space used as the temporary storage space when the standby-mode node is switched to the operating-mode node; and
a synchronization storage space for storing process-completion data received at a time of the data synchronization; and
a second processor coupled to the second memory and the second processor configured to:
when the predetermined process-completion data is received from the operating-mode node, store the predetermined process-completion data in the standby-mode temporary storage space; and
store the un-transmitted process-completion data received from the operating-mode node and the process-completion data stored in the standby-mode temporary storage space in the synchronization storage space after the operating-mode node completes the executions of all the process commands included in the batch process request.

3. The data management system according to claim 1, wherein
the first processor is further configured to:
receive the batch process request in which an execution order of the plurality of process commands is determined in advance;
sequentially execute the process commands in accordance with the execution order; and
in a case where specific process-completion data stored in the temporary storage space is referred to in the processing for the another process request, transmit the specific process-completion data and process-completion data corresponding to a process command executed before a process command corresponding to the specific process-completion data to the standby-mode node.

4. The data management system according to claim 1, wherein
the first processor is further configured to:
after the processing for the another process request is completed, transmit the predetermined process-completion data together with process-completion data corresponding to the processing for the another process request to the standby-mode node.

5. The data management system according to claim 1, wherein
the first processor is further configured to:
execute a process command included in the batch process request other than a process command corresponding to process-completion data stored in the temporary storage space.

6. A data management method, comprising:
processing, by a computer, a received process request;
in a case where the received process request is a batch process request which includes a plurality of process commands, sequentially executing each of the process commands included in the batch process request;
storing process-completion data corresponding to each of the process commands in a temporary storage space every time the execution of each of the process commands is completed;
in a case where the process-completion data stored in the temporary storage space is referred to in processing for another process request, transmitting predetermined process-completion data to a standby-mode node based on a reference state of the temporary storage space; and
when execution of all the process commands included in the batch process request is completed, transmitting un-transmitted process-completion data, which is process-completion data not yet transmitted, to the standby-mode node to perform data synchronization.

7. A non-transitory computer-readable recording medium storing a program for causing a computer to execute a process, the process comprising:
processing a received process request;
in a case where the received process request is a batch process request which includes a plurality of process commands, sequentially executing each of the process commands included in the batch process request;
storing process-completion data corresponding to each of the process commands in a temporary storage space every time the execution of each of the process commands is completed;
in a case where the process-completion data stored in the temporary storage space is referred to in processing for another process request, transmitting predetermined process-completion data to a standby-mode node based on a reference state of the temporary storage space; and
when execution of all the process commands included in the batch process request is completed, transmitting un-transmitted process-completion data, which is process-completion data not yet transmitted, to the standby-mode node to perform data synchronization.
